(19) United States
(12) Patent Application Publication
(10) Pub. No.: US 2024/0014449 A1
(43) Pub. Date: Jan. 11, 2024

(54) ZINC SECONDARY BATTERY

(71) Applicant: NGK INSULATORS, LTD., Nagoya (JP)

(72) Inventors: Minoru TANIMOTO, Nagoya (JP); Takeshi YAGI, Nagoya (JP)

(21) Appl. No.: 18/472,490

(22) Filed: Sep. 22, 2023

Related U.S. Application Data
(63) Continuation of application No. PCT/JP2021/046483, filed on Dec. 16, 2021.

(30) Foreign Application Priority Data
Mar. 26, 2021 (JP) 2021-054026

(51) Int. Cl. H01M 10/28; H01M 4/24; H01M 50/46; H01M 10/42; H01M 50/434; H01M 50/449; H01M 50/411; H01M 4/32; H01M 10/30; H01M 12/08

(52) U.S. Cl. CPC H01M 10/28; H01M 4/244; H01M 50/46; H01M 10/4235; H01M 50/434; H01M 50/449; H01M 50/411; H01M 4/32; H01M 10/30; H01M 12/08; H01M 2004/027

(57) ABSTRACT

There is provided a zinc secondary battery including a unit cell including: a positive electrode plate; a negative electrode plate; a nonwoven fabric covering or wrapping up each of the positive electrode plate and the negative electrode plate; a hydroxide ion conductive separator; and an electrolytic solution; and a battery container housing the unit cell. Each element is vertically arranged, and an excessive portion of the electrolytic solution is always retained on a bottom of the battery container in an amount corresponding to a liquid level lower than lower ends of the positive electrode plate and the negative electrode plate. The nonwoven fabric covering or wrapping up the positive electrode plate has a lower extension portion contactable with the excessive portion of the electrolytic solution, and a lower end of the lower extension portion is always positioned below the liquid level of the excessive portion of the electrolytic solution.

### CROSS-REFERENCE TO RELATED APPLICATIONS

This application is a continuation application of PCT/JP2021/046483 filed Dec. 16, 2021, which claims priority to Japanese Patent Application No. 2021-054026 filed Mar. 26, 2021, the entire contents all of which are incorporated herein by reference.

### BACKGROUND OF THE INVENTION

### 1. Field of the Invention

The present disclosure relates to a zinc secondary battery.

### 2. Description of the Related Art

It is known that in zinc secondary batteries such as a nickel-zinc secondary battery and an air-zinc secondary battery, metallic zinc in a dendrite form precipitates from a negative electrode upon charge, penetrates voids of a separator such as a nonwoven fabric, and reaches a positive electrode, resulting in occurrence of a short circuit. This short circuit due to such zinc dendrites leads to shorten repeated charge/discharge life. In order to deal with the problems described above, a battery comprising a layered double hydroxide (LDH) separator that blocks the penetration of zinc dendrite while selectively permeating hydroxide ions has been proposed. For example, Patent Literature 1 (WO2013/118561) discloses a nickel-zinc secondary battery including a LDH separator provided between a positive electrode and a negative electrode. Patent Literature 2 (WO2016/076047) discloses a separator structure comprising an LDH separator fitted or joined to a resin outer frame, wherein the LDH separator has a high denseness such that it has a gas impermeability and/or water impermeability. Moreover, the literature also discloses that the LDH separator can be composited with a porous substrate. Further, Patent Literature 3 (WO2016/067884) discloses various methods for forming an LDH dense membrane on a surface of a porous substrate to obtain a composite material. This method comprises steps of uniformly adhering a starting material that can impart a starting point for LDH crystal growth to the porous substrate, treating hydrothermally the porous substrate in a raw material aqueous solution to form an LDH dense membrane on a surface of the porous substrate. An LDH separator further densified by roll pressing of a composite material of an LDH/porous substrate produced by hydrothermal treatment has been also proposed. For example, Patent Literature 4 (WO2019/124270) discloses an LDH separator comprising a polymer porous substrate, and an LDH filled in the porous substrate, and having a linear transmittance at a wavelength of 1000 nm of 1% or more.

Moreover, LDH-like compounds have being known as hydroxides and/or oxides with a layered crystal structure that cannot be called LDH but are analogous thereto, which exhibit hydroxide ion conductive properties similar to those of a compound to an extent that it can be collectively referred to as hydroxide ion conductive layered compounds together with LDH. For example, Patent Literature 5 (WO2020/255856) discloses a hydroxide ion conductive separator comprising a porous substrate and a layered double hydroxide (LDH)-like compound that clogs up pores in the porous substrate, in which the LDH-like compound is a hydroxide and/or an oxide with a layered crystal structure containing Mg, and one or more elements including at least Ti and selected from the group consisting of Ti, Y and Al. It is described that this hydroxide ion conductive separator is excellent in alkali resistance as compared with a conventional LDH separator, and can further effectively inhibit a short circuit due to zinc dendrite.

By the way, Patent Literature 6 (WO2019/069760) and Patent Literature 7 (WO2019/077953) have proposed a zinc secondary battery having a configuration in which the whole of a negative electrode active material layer is covered or wrapped up with a liquid holding member and an LDH separator, and a positive electrode active material layer is covered or wrapped up with a nonwoven fabric. It is described that according to such a configuration, complicated sealing and bonding between the LDH separator and a battery container is unnecessary, and hence a zinc secondary battery (especially a stacked-cell battery thereof) capable of preventing zinc dendrite propagation can be produced extremely easily and with high productivity.

### CITATION LIST

### Patent Literature

Patent Literature 1: WO2013/118561
Patent Literature 2: WO2016/076047
Patent Literature 3: WO2016/067884
Patent Literature 4: WO2019/124270
Patent Literature 5: WO2020/255856
Patent Literature 6: WO2019/069760
Patent Literature 7: WO2019/077953

### SUMMARY OF THE INVENTION

There is a demand for further elongation of cycle life and calendar life of a zinc secondary battery. In the zinc secondary batteries having the conventional configurations as described in Patent Literatures 6 and 7, however, a phenomenon that an electrolytic solution depletes in a positive electrode section (hereinafter referred to as electrolyte depletion) may occur. Such electrolyte depletion deteriorates charge/discharge characteristics, resulting in reducing the cycle life and the calendar life.

The inventors have now found that, in a zinc secondary battery vertically including a positive electrode plate and a negative electrode plate, electrolyte depletion in a positive electrode can be effectively prevented by configuring the zinc secondary battery so that an excessive portion of an electrolytic solution be always retained in an amount corresponding to a liquid level lower than the lower ends of the positive electrode plate and the negative electrode plate, and that a nonwoven fabric covering or wrapping up the positive electrode plate have a lower extension portion contactable with the excessive portion of the electrolytic solution.

Accordingly, an object of the present invention is to provide a zinc secondary battery capable of effectively preventing electrolyte depletion in a positive electrode section.

According to an aspect of the present invention, there is provided a zinc secondary battery, comprising:
a unit cell, comprising:
   a positive electrode plate including a positive electrode active material layer;
   a negative electrode plate including a negative electrode active material layer containing at least one selected from the group consisting of zinc, zinc oxide, a zinc alloy, and a zinc compound;
   a nonwoven fabric covering or wrapping up each of the positive electrode plate and the negative electrode plate;
   a hydroxide ion conductive separator separating the positive electrode plate and the negative electrode plate so as to make hydroxide ions conductable; and
   an electrolytic solution; and
a battery container housing the unit cell,
wherein each of the positive electrode plate, the negative electrode plate, and the hydroxide ion conductive separator is vertically arranged, and an excessive portion of the electrolytic solution is always retained on a bottom of the battery container in an amount corresponding to a liquid level lower than lower ends of the positive electrode plate and the negative electrode plate regardless of change in an amount of the electrolyte caused by charge/discharge, and
wherein the nonwoven fabric covering or wrapping up the positive electrode plate has a lower extension portion contactable with the excessive portion of the electrolytic solution, and a lower end of the lower extension portion is always positioned below the liquid level of the excessive portion of the electrolytic solution regardless of change in an amount of the electrolyte caused by charge/discharge, whereby the nonwoven fabric is capable of absorbing the excessive portion of the electrolytic solution by capillary action thereof upward from the lower end thereof.

### BRIEF DESCRIPTION OF THE DRAWINGS

FIG. 1 is a schematic cross-sectional view illustrating an example of a zinc secondary battery of the present invention.

FIG. 2 is a view schematically illustrating A-A′ cross section of the zinc secondary battery shown in FIG. 1.

FIG. 3 is a view schematically illustrating a positive electrode plate wrapped up with a nonwoven fabric and included in the zinc secondary battery shown in FIG. 1.

FIG. 4 is a perspective view schematically illustrating battery components of the zinc secondary battery shown in FIG. 1.

FIG. 5 is a cross-sectional view schematically illustrating the battery components of the zinc secondary battery shown in FIG. 1.

FIG. 6 is a schematic cross-sectional view conceptually illustrating an electrolyte absorption structure in the zinc secondary battery of the present invention.

FIG. 7 is a schematic cross-sectional view conceptually illustrating the configuration of a conventional zinc secondary battery.

### DETAILED DESCRIPTION OF THE INVENTION

Zinc Secondary Battery

A zinc secondary battery of the present invention is not especially limited as long as it is a secondary battery using zinc as a negative electrode and using an alkaline electrolytic solution (representatively, an alkali metal hydroxide aqueous solution). Accordingly, it can be a nickel-zinc secondary battery, a silver oxide-zinc secondary battery, a manganese oxide-zinc secondary battery, an air-zinc secondary battery, or any of other various alkaline zinc secondary batteries. For example, it is preferred that a positive electrode active material layer contains nickel hydroxide and/or nickel oxyhydroxide, whereby the zinc secondary battery is configured as a nickel-zinc secondary battery. Alternatively, a positive electrode active material layer may be an air electrode layer, whereby the zinc secondary battery is configured as an air-zinc secondary battery.

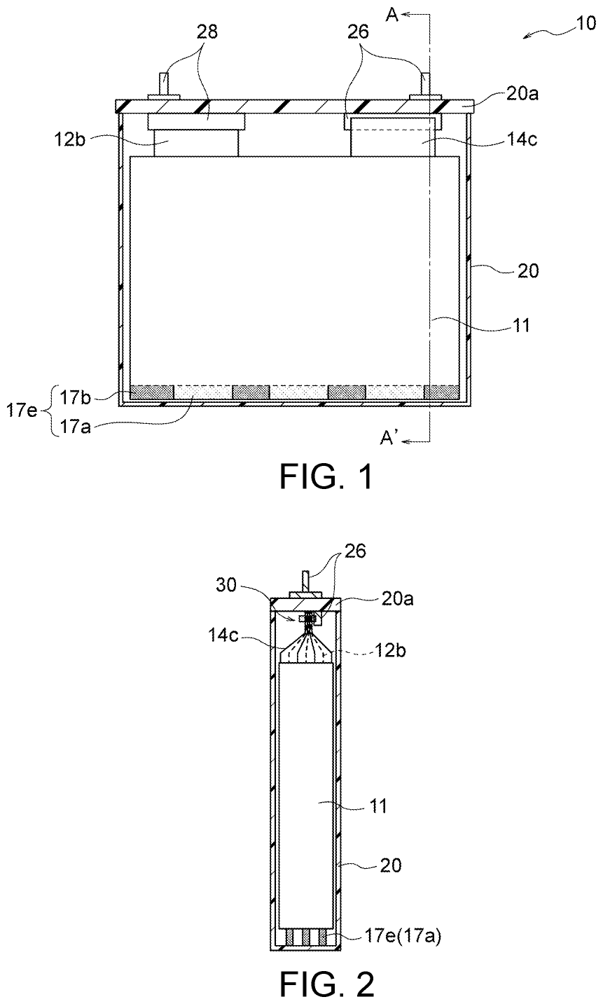

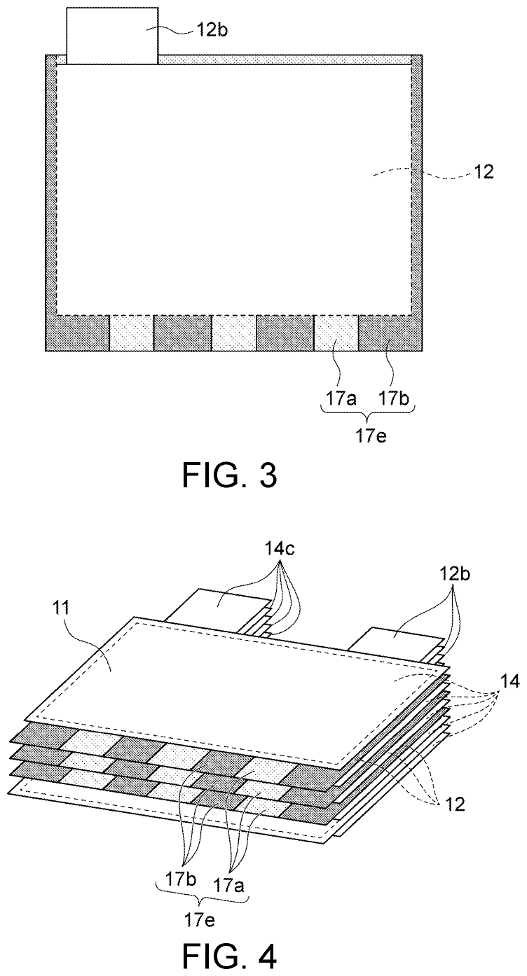

FIGS. 1 to 6 illustrate one aspect of the zinc secondary battery of the present invention and its internal structure. The zinc secondary battery 10 illustrated in these drawings is obtained by housing battery components 11 in a battery container 20, and the battery components 11 include unit cells 10a each including a positive electrode plate 12, a negative electrode plate 14, a nonwoven fabric 17, a hydroxide ion conductive separator 16, and an electrolytic solution 18. The positive electrode plate 12 includes a positive electrode active material layer. The negative electrode plate 14 includes a negative electrode active material layer 14a, and the negative electrode active material layer 14a contains at least one selected from the group consisting of zinc, zinc oxide, a zinc alloy, and a zinc compound. The nonwoven fabric 17 covers or wraps up each of the positive electrode plates 12 and the negative electrode plates 14. The hydroxide ion conductive separator 16 separates the positive electrode plate 12 and the negative electrode plate 14 such that hydroxide ions can be conducted. Each of the positive electrode plates 12, the negative electrode plates 14, and the hydroxide ion conductive separators 16 is vertically arranged. On a bottom of the battery container 20, an excessive portion of the electrolytic solution 18 is always retained in an amount corresponding to a liquid level lower than the lower ends of the positive electrode plates 12 and the negative electrode plates 14 regardless of change in the amount of electrolyte caused by charge/discharge. The nonwoven fabric 17 covering or wrapping up the positive electrode plate 12 has a lower extension portion 17e contactable with the excessive portion of the electrolytic solution 18, and a lower end of the lower extension portion 17e is always positioned below the liquid level of the excessive portion of the electrolytic solution 18 regardless of the change in the amount of electrolyte caused by charge/discharge. Therefore, the nonwoven fabric 17 can absorb, by capillary action thereof, the excessive portion of the electrolytic solution 18 upward from the lower end thereof. In this manner, the zinc secondary battery 10 vertically including the positive electrode plate 12 and the negative electrode plate 14 is configured so that the excessive portion of the electrolytic solution 18 be always retained in an amount corresponding to a liquid level lower than the lower ends of the positive electrode plate 12 and the negative electrode plate 14, and that the nonwoven fabric 17 covering or wrapping up the positive electrode plate 12 have the lower extension portion 17e contactable with the excessive portion of the electrolytic solution 18, and therefore, electrolyte depletion otherwise caused in a positive electrode section can be effectively prevented.

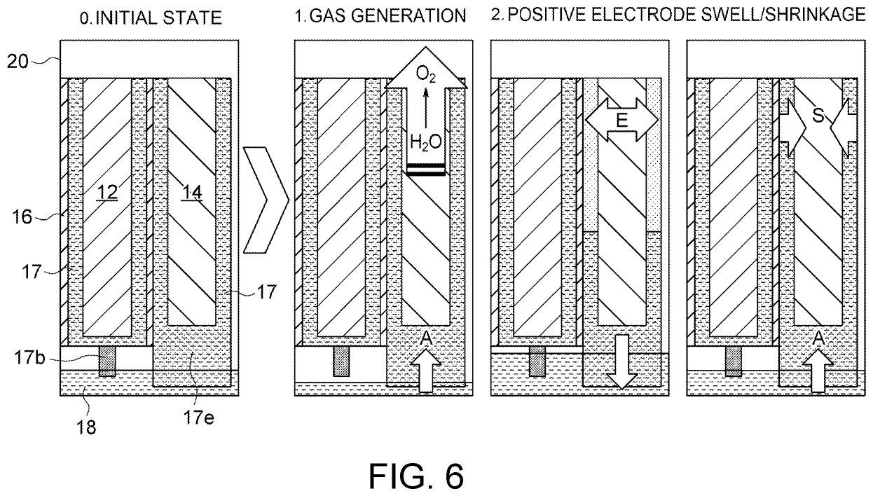

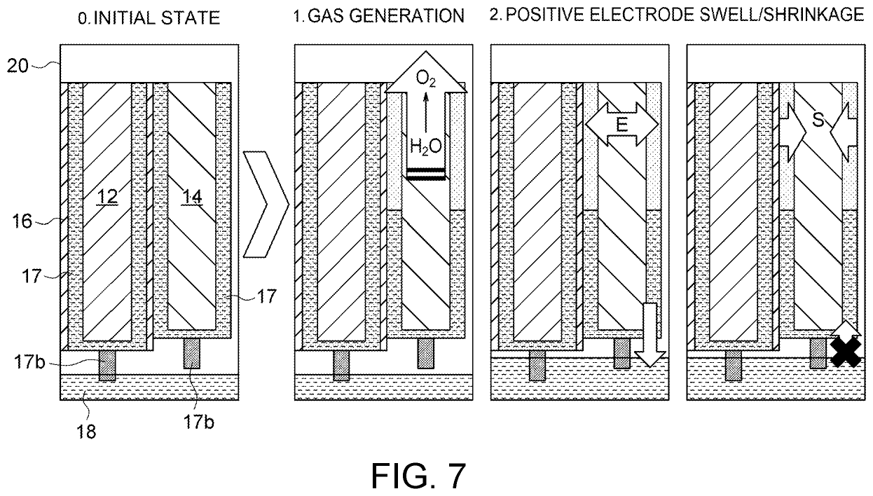

In other words, as described above, in the zinc secondary batteries having the conventional configurations as described in Patent Literatures 6 and 7, a phenomenon that the electrolytic solution depletes in a positive electrode section (electrolyte depletion) may occur. Such electrolyte depletion deteriorates charge/discharge characteristics, resulting in reducing the cycle life and the calendar life. There are two causes of the electrolyte depletion as illustrated in FIG. 7, that is, 1) that water is consumed due to oxygen gas generation in the positive electrode through charge/discharge and self-discharge, and 2) that water discharged from the nonwoven fabric 17 at the time of expansion (E in the drawing) of the positive electrode plate 12 cannot be absorbed at the time of shrinkage (S in the drawing) of the positive electrode plate 12. The electrolyte depletion can result in charge/discharge efficiency degradation due to resistance increase, and overcharge due to local current crowding caused by the electrolyte depletion. Such problems can be advantageously solved by the configuration of the present invention. In other words, in the present invention, as illustrated in FIG. 6, the nonwoven fabric 17 covering or wrapping up the positive electrode plate 12 is extended downward to have the lower extension portion 17e to be always contactable with the excessive portion of the electrolytic solution 18, and thus, the nonwoven fabric 17 can automatically absorb, by the capillary action thereof, the excessive portion of the electrolytic solution 18 upward from the lower end thereof (A in the drawing). As a result, i) water consumed due to oxygen gas generation can be supplemented from the excessive portion of the electrolytic solution 18 as well as ii) water discharged from the nonwoven fabric 17 at the time of expansion (E in the drawing) of the positive electrode plate 12 can be supplemented at the time of shrinkage (S in the drawing) of the positive electrode plate 12 from the excessive portion of the electrolytic solution 18. In other words, the above-described two causes can be eliminated, and thus, the electrolyte depletion in the positive electrode section can be effectively prevented.

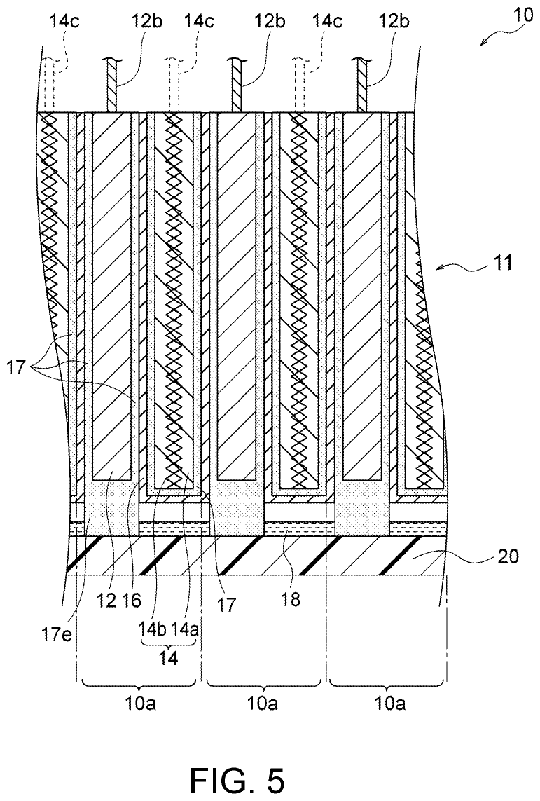

The positive electrode plate 12 includes the positive electrode active material layer 12a. A positive electrode active material contained in the positive electrode active material layer 12a is not especially limited, and may be appropriately selected from known positive electrode materials in accordance with the type of zinc secondary battery. For example, in a nickel-zinc secondary battery, a positive electrode containing nickel hydroxide and/or nickel oxyhydroxide may be used. Alternatively, in an air-zinc secondary battery, an air electrode may be used as the positive electrode. The positive electrode plate 12 further includes a positive electrode current collector (not shown), and the positive electrode current collector preferably has a positive electrode current collector tab 12b extending in a predetermined direction (for example, upward) from an end (for example, an upper end) of the positive electrode plate 12. A preferred example of the positive electrode current collector includes a nickel porous substrate such as a foam nickel plate. In this case, for example, when a paste containing an electrode active material such as nickel hydroxide is uniformly applied on a nickel porous substrate, and the resultant is dried, a positive electrode plate including a positive electrode/positive electrode current collector can be favorably produced. At this point, it is also preferred that the dried positive electrode plate (namely, the positive electrode/positive electrode current collector) is subjected to pressing to prevent the electrode active material from coming off and to improve electrode density. Although the positive electrode plate 12 illustrated in FIG. 5 includes a positive electrode current collector (of, for example, foam nickel), it is not illustrated therein. This is because the positive electrode current collector and the positive electrode active material are completely mixed in a nickel-zinc secondary battery, and hence the positive electrode current collector cannot be individually illustrated. The positive electrode current collector tab 12b may be composed of the same material as the positive electrode current collector, or may be composed of a different material. When the positive electrode current collector is a nickel porous substrate such as a foam nickel plate, the porous substrate may be processed into a tab by pressing. In any case, the positive electrode current collector tab 12b may be extended by splicing, to such a tab, another current collector member such as a tab lead. In any case, it is preferred that a plurality of positive electrode current collector tabs 12b are bonded to one positive electrode terminal 26 or a member electrically connected thereto to constitute a positive electrode tab bonding portion (not shown). In this manner, current collection can be conducted with a simple configuration and with high space efficiency, and connection to the positive electrode terminal 26 can be eased. The positive electrode current collector tab 12b and a member such as a terminal are bonded by any of known bonding methods such as ultrasonic welding (ultrasonic bonding), laser welding, TIG welding, and resistance welding.

The positive electrode plate 12 may contain an additive that is at least one selected from the group consisting of a silver compound, a manganese compound, and a titanium compound, and thus, a positive electrode reaction for absorbing hydrogen gas generated through self-discharge reaction can be accelerated. Besides, the positive electrode plate 12 may further contain cobalt. Cobalt is contained in the positive electrode plate 12 preferably in the form of cobalt oxyhydride. In the positive electrode plate 12, cobalt functions as a conductive auxiliary agent to contribute to improvement of charge/discharge capacity.

The negative electrode plate 14 includes the negative electrode active material layer 14a. A negative electrode active material contained in the negative electrode active material layer 14a contains at least one selected from the group consisting of zinc, zinc oxide, a zinc alloy, and a zinc compound. The zinc may be contained in any form of a zinc metal, a zinc compound, and a zinc alloy as long as it has electrochemical activity suitable for the negative electrode. Preferred examples of the negative electrode material include zinc oxide, a zinc metal, and calcium zincate, and a mixture of a zinc metal and zinc oxide is more preferred. The negative electrode active material may be in the form of a gel, or may be mixed with the electrolytic solution 18 to obtain a negative electrode mixture. For example, a gelled negative electrode can be easily obtained by adding an electrolytic solution and a thickener to a negative electrode active material. Examples of the thickener include polyvinyl alcohol, polyacrylate, CMC, and alginic acid, and polyacrylic acid is preferred because of excellent chemical resistance to strong alkali.

As the zinc alloy, a zinc alloy containing neither mercury nor lead, known as mercury-free zinc alloy, can be used. For example, a zinc alloy containing 0.01 to 0.1% by mass of indium, 0.005 to 0.02% by mass of bismuth, and 0.0035 to 0.015% by mass of aluminum is preferred because it has an effect of inhibiting hydrogen gas generation. In particular, indium and bismuth are advantageous in improving discharge performance. When a zinc alloy is used in the negative electrode, a self-dissolution rate in an alkaline electrolytic solution is decreased to inhibit hydrogen gas generation, and thus, safety can be improved.

The shape of the negative electrode material is not especially limited, and is preferably a powder shape, and thus, the surface area is increased to cope with large current discharge. A preferred average particle size of the negative electrode material is, in using a zinc alloy, in a range of 3 to 100 μm in minor axis, and when the average particle size is within this range, the surface area is so large that large current discharge can be suitably coped with, and in addition, the material can be easily homogeneously mixed with an electrolytic solution and a gelling agent, and handleability in assembling the battery is favorable.

The negative electrode plate 14 preferably further includes a negative electrode current collector 14b. The negative electrode current collector 14b is provided inside and/or on the surface of the negative electrode active material layer 14a excluding a portion thereof extending as a negative electrode current collector tab 14c. In other words, the negative electrode active material layer 14a may be arranged on both surfaces of the negative electrode current collector 14b, or the negative electrode active material layer 14a may be arranged on merely one surface of the negative electrode current collector 14b. The negative electrode current collector tab 14c extends in a predetermined direction (for example, upward) from an end (for example, an upper end) of the negative electrode plate 14 in a position not overlapping with the positive electrode current collector tab 12b. The negative electrode current collector tab 14c is provided preferably in a position not overlapping with the positive electrode current collector tab 12b. The negative electrode current collector tab 14c may be composed of the same material as the negative electrode current collector 14b, or may be composed of a different material. In any case, the negative electrode current collector tab 14c may be extended by splicing, to such a tab, another current collector member such as a tab lead. In any case, it is preferred that a plurality of negative electrode current collector tabs 14c are bonded to one negative electrode terminal 28 or a member electrically connected thereto to constitute a negative electrode tab bonding portion 30. In this manner, current collection can be conducted with a simple configuration and with high space efficiency, and connection to the negative electrode terminal 28 can be eased. The negative electrode current collector tab 14c and a member such as a terminal are bonded by any of known bonding methods such as ultrasonic welding (ultrasonic bonding), laser welding, TIG welding, and resistance welding.

The negative electrode current collector 14b preferably uses a metal plate having a plurality of (or a large number of) openings from the viewpoint of fixing the negative electrode active material on the current collector. Preferred examples of such a negative electrode current collector 14b include an expanded metal, a punched metal, a metal mesh, and a combination thereof, more preferred examples include a copper expanded metal, a copper punched metal, and a combination thereof, and a particularly preferred example includes a copper expanded metal. In this case, for example, a negative electrode plate including a negative electrode/negative electrode collector can be favorably produced by applying, on a copper expanded metal, a mixture containing a zinc oxide powder and/or a zinc powder, and optionally a binder (for example, a polytetrafluoroethylene particle). At this point, it is also preferred that the dried negative electrode plate (namely, the negative electrode/negative electrode current collector) is subjected to pressing to prevent the electrode active material from coming off and to improve electrode density. An expanded metal refers to a mesh-shaped metal plate obtained by forming and expanding staggered cuts in a metal plate with an expanded metal machine, and shaping the cuts into a diamond shape or a hexagonal shape. A punched metal is also designated as a perforated metal, and refers to a metal plate provided with holes by punching. A metal mesh is a metal product having a wire mesh structure, and is different from an expanded metal and a punched metal.

The hydroxide ion conductive separator 16 is provided to separate the positive electrode plate 12 and the negative electrode plate 14 such that hydroxide ions can be conducted. For example, as illustrated in FIG. 5, the negative electrode plate 14 may be covered or wrapped up with the hydroxide ion conductive separator 16, and it is particularly preferred that the negative electrode plate 14 is covered or wrapped up with the hydroxide ion conductive separator 16 from outside the nonwoven fabric 17 covering or wrapping up the negative electrode plate 14. Thus, complicated sealing and bonding between the hydroxide ion conductive separator 16 and the battery container is unnecessary, and hence a zinc secondary battery (especially a stacked-cell battery thereof) capable of preventing zinc dendrite propagation can be produced extremely easily and with high productivity. A simple configuration in which the hydroxide ion conductive separator 16 is arranged on one side of the positive electrode plate 12 or the negative electrode plate 14 may be employed.

The hydroxide ion conductive separator 16 is not especially limited as long as it is a separator capable of separating the positive electrode plate 12 and the negative electrode plate 14 such that hydroxide ions can be conducted, and representatively is a separator that contains a hydroxide ion conductive solid electrolyte, and selectively passes hydroxide ions by solely utilizing hydroxide ion conductivity. A preferred hydroxide ion conductive solid electrolyte is a layered double hydroxide (LDH) and/or an LDH-like compound. Accordingly, the hydroxide ion conductive separator 16 is preferably an LDH separator. The “LDH separator” herein is a separator containing an LDH and/or an LDH-like compound, and is defined as a separator that selectively passes hydroxide ions by solely utilizing hydroxide ion conductivity of the LDH and/or the LDH-like compound. The “LDH-like compound” herein is a hydroxide and/or oxide having a layered crystal structure analogous to LDH but is a compound that may not be called LDH, and it can be said to be an equivalent of LDH. However, according to a broad sense of definition, it can be appreciated that “LDH” encompasses not only LDH but also LDH-like compounds. The LDH separator is preferably composited with a porous substrate. Accordingly, it is preferred that the LDH separator further includes a porous substrate, and is composited with the porous substrate with the LDH and/or the LDH-like compound filled in pores in the porous substrate. In other words, in a preferred LDH separator, the LDH and/or the LDH-like compound clogs up pores in the porous substrate so that hydroxide ion conductivity and gas impermeability can be exhibited (thereby the LDH separator can function as an LDH separator exhibiting hydroxide ion conductivity). The porous substrate is preferably made of a polymer material, and the LDH and/or the LDH-like compound is particularly preferably incorporated over the entire area in the thickness direction of the porous substrate made of a polymer material. For example, known LDH separators disclosed in Patent Literatures 1 to 7 can be used. The thickness of the LDH separator is preferably 5 to 100 μm, more preferably 5 to 80 μm, further preferably 5 to 60 μm, and particularly preferably 5 to 40 μm.

The nonwoven fabric 17 is provided to cover or wrap up each of the positive electrode plates 12 and the negative electrode plates 14 as illustrated in FIG. 5. Since the nonwoven fabric 17 is thus interposed, the electrolytic solution 18 can be uniformly present between the positive electrode plate 12 and the negative electrode plate 14, and the hydroxide ion conductive separator 16, and thus, hydroxide ions can be efficiently transferred between each of the positive electrode plate 12 and the negative electrode plate 14, and the hydroxide ion conductive separator 16. The nonwoven fabric 17 has a thickness of preferably to 50 to 150 μm, more preferably 50 to 120 μm, and further preferably 50 to 100 μm. When the thickness falls in this range, with the entire size of a positive electrode structure and/or a negative electrode structure efficiently suppressed to be compact, a sufficient amount of the electrolytic solution 18 can be held in the nonwoven fabric 17. Besides, electrolyte absorption efficiency from the lower extension portion 17e can be favorable. From the viewpoints of electrolyte retention performance and electrolyte absorption performance, the nonwoven fabric 17 is preferably composed of at least one selected from polyolefin (such as polyethylene or polypropylene), cellulose, and vinylon. The nonwoven fabric is particularly preferably composed of polyolefin (such as polyethylene or polypropylene) from the viewpoint that it is suitable for thermal welding. The surface of the nonwoven fabric 17 is preferably subjected to hydrophilization treatment for improving the electrolyte retention performance and the electrolyte absorption performance. Examples of the hydrophilization treatment include sulfonation treatment, fluorine gas treatment, plasma treatment, graft treatment (such as electron beam graft polymerization), and corona treatment. Besides, the electrolyte absorption performance of the nonwoven fabric 17 can be further improved by adding a surfactant.

When the positive electrode plate 12 and/or the negative electrode plate 14 are covered or wrapped up with the nonwoven fabric 17 and/or the separator 16, outer edges thereof (excluding a side on which the positive electrode current collector tab 12b or the negative electrode current collector tab 14c is extended) are preferably closed. In this case, closed sides of the outer edges of the nonwoven fabric 17 and/or the separator 16 are preferably realized by bending the nonwoven fabric 17 and/or the separator 16, or sealing the edges of the nonwoven fabric 17 and/or the edges of the separator 16. Preferred examples of the sealing method include an adhesive, thermal welding, ultrasonic welding, an adhesive tape, a sealing tape, and a combination thereof. In particular, an LDH separator including a porous substrate made of a polymer material has flexibility, and hence is advantageously easily bent, and therefore, it is preferred that the LDH separator formed into a rectangular shape is bent to obtain a state where one side of the outer edges is closed. For thermal welding and ultrasonic welding, a commercially available heat sealer or the like may be used, and in sealing the edges of an LDH separator, it is preferred to perform the thermal welding and the ultrasonic welding with an outer circumferential portion of the nonwoven fabric 17 sandwiched between outer circumferential portions of the LDH separator because the sealing can be thus more effectively performed. On the other hand, as an adhesive, an adhesive tape, and a sealing tape, commercially available products may be used, and in order to prevent deterioration otherwise caused in an alkaline electrolytic solution, one containing an alkali resistant resin is preferred. From this point of view, preferred examples of the adhesive include an epoxy resin-based adhesive, a natural resin-based adhesive, a modified olefin resin-based adhesive, and a modified silicone resin-based adhesive, among which an epoxy resin-based adhesive is more preferred because of excellent alkali resistance. An example of products of the epoxy resin-based adhesive includes an epoxy adhesive, Hysol® (manufactured by Henkel).

As described above, the lower end of the lower extension portion 17e of the nonwoven fabric 17 covering or wrapping up the positive electrode plate 12 is always positioned below the liquid level of the excessive portion of the electrolytic solution 18, and therefore, the nonwoven fabric 17 can absorb, by capillary action thereof, the excessive portion of the electrolytic solution 18 upward from the lower end thereof. Accordingly, a portion at the lower end of the lower extension portion 17e where the electrolyte absorption performance of the nonwoven fabric 17 is impaired by welding (welded portion) does not absorb the electrolyte even in contact with the electrolytic solution 18. Therefore, the lower end of the lower extension portion 17e of the nonwoven fabric 17 covering or wrapping up the positive electrode plate 12 may have a portion where the electrolyte absorption performance of the nonwoven fabric 17 is impaired (welded portion), but in such a case, is desired to separately have a portion not welded where the electrolyte absorption performance is not impaired (unwelded portion).

Preferably, the nonwoven fabric 17 in contact with one surface of the positive electrode plate 12 and the nonwoven fabric 17 in contact with another surface of the positive electrode plate 12 are thermally mutually welded in a part of their lower extension portions 17e to together form a welded portion 17b, and a remaining part of the lower extension portions 17e is an unwelded portion 17a not thermally welded, and a lower end of the unwelded portion 17a is always positioned below the liquid level of the excessive portion of the electrolytic solution 18. In such a configuration, the lower end of the positive electrode plate 12 can be kept at the upper end of the welded portion 17b in a position higher than the liquid level of the electrolytic solution 18, and on the other hand, the nonwoven fabric 17 can efficiently absorb the excessive portion of the electrolytic solution 18 via the unwelded portion 17a. In particular, an aspect of intermittent welding in which the unwelded portion 17a and the welded portion 17b are alternately provided as illustrated in FIGS. 1, 3, and 4 is particularly preferred from the viewpoint of attaining both alignment of the positive electrode plate 12 and the electrolyte absorption performance.

The outer edge on one side corresponding to the upper edge of the separator 16 is preferably opened. Such a top open type configuration makes it possible to deal with a problem occurring upon overcharge in a nickel-zinc battery and the like. Specifically, when a nickel-zinc battery or the like is overcharged, oxygen (O₂) can be generated in the positive electrode plate 12, but the LDH separator has such a high density as to substantially pass only hydroxide ions, and hence does not pass O₂. In this regard, when the above-described top open type configuration is employed, O₂ can be transferred above the positive electrode plate 12 to be sent toward the negative electrode plate 14 through the top open portion in the battery container 20, and thus, Zn of a negative electrode active material can be oxidized with the O₂ to be restored to ZnO. Owing to such an oxygen reaction cycle, overcharge resistance can be improved by using top open type battery components 11 in a sealed zinc secondary battery. Even when the outer edge on one side corresponding to the upper edge of the separator 16 or the nonwoven fabric 17 is closed, the same effect as that obtained by the open type configuration can be expected by providing a vent hole in a part of the closed outer edge. For example, a vent hole may be formed after sealing the outer edge on one side corresponding to the upper edge of the LDH separator, or a part of the outer edge may be left unsealed in sealing so as to form a vent hole therein.

The electrolytic solution 18 preferably contains an alkali metal hydroxide aqueous solution. Although the electrolytic solution 18 is merely locally illustrated in FIG. 5, this is because the electrolytic solution spreads all over the positive electrode plate 12 and the negative electrode plate 14. Examples of an alkali metal hydroxide include potassium hydroxide, sodium hydroxide, lithium hydroxide, and ammonium hydroxide, and potassium hydroxide is more preferred. In order to inhibit self-dissolution of zinc and/or zinc oxide, a zinc compound such as zinc oxide, or zinc hydroxide may be added to the electrolytic solution. As described above, the electrolytic solution may be mixed with the positive electrode active material and/or the negative electrode active material so as to be present in the form of a positive electrode mixture and/or a negative electrode mixture. Besides, the electrolytic solution may be gelled for preventing leakage of the electrolytic solution. As a gelling agent, a polymer that absorbs a solvent of the electrolytic solution to swell is preferably used, and a polymer such as polyethylene oxide, polyvinyl alcohol, or polyacrylamide, or starch is used.

The battery components 11 are formed, as illustrated in FIGS. 1 to 5, into a positive/negative electrode laminate including a plurality of positive electrode plates 12, a plurality of negative electrode plates 14, and a plurality of separators 16 in which a unit of the positive electrode plate 12/the separator 16/the negative electrode 14 is repeatedly stacked. In other words, the zinc secondary battery 10 includes a plurality of unit cells 10a, and thus, the plurality of unit cells 10a form a multilayer cell as a whole. This is a configuration of what is called a battery pack or stacked cell battery, and this configuration is advantageous in obtaining a high voltage and a large current.

The battery container 20 is preferably made of a resin. The resin constituting the battery container 20 is preferably a resin having resistance to an alkali metal hydroxide such as potassium hydroxide, more preferably a polyolefin resin, an ABS resin, or modified polyphenylene ether, and further preferably an ABS resin or modified polyphenylene ether. The battery container 20 has a top cover 20a. The battery container 20 (for example, the upper cover 20a) may have a pressure release valve for releasing a gas. Besides, a container group in which two or more battery containers 20 are arranged may be housed in an outer frame to obtain a configuration of a battery module.

LDH-Like Compounds

According to a preferred aspect of the present invention, the LDH separator can be a separator that contains an LDH-like compound. The definition of the LDH-like compound is as described above. Preferred LDH-like compounds are as follows,
(a) a hydroxide and/or oxide having a layered crystal structure containing Mg and one or more elements selected from the group consisting of Ti, Y, and Al, and containing at least Ti; or
(b) a hydroxide and/or oxide having a layered crystal structure containing (i) Ti, Y, optionally Al and/or Mg, and (ii) at least one additive element M selected from the group consisting of In, Bi, Ca, Sr and Ba, or
(c) a hydroxide and/or oxide having a layered crystal structure containing Mg, Ti, Y, optionally Al and/or In, wherein in (c), the LDH-like compound is present in a form of mixture with In(OH)₃.

According to the preferred aspect (a) of the present invention, the LDH-like compound can be a hydroxide and/or oxide having a layered crystal structure containing Mg and one or more elements selected from the group consisting of Ti, Y and Al and containing at least Ti. Thus, a typical LDH-like compound is a complex hydroxide and/or complex oxide of Mg, Ti, optionally Y and optionally Al. The above elements may be replaced with other elements or ions to an extent that the basic characteristics of the LDH-like compound are not impaired, but the LDH-like compound preferably contains no Ni. For example, the LHD-like compound may be a compound further containing Zn and/or K. In such a manner, ionic conductivity of the LDH separator can be further improved.

LDH-like compounds can be identified by X-ray diffraction. Specifically, when X-ray diffraction is carried out on the surface of the LDH separator, a peak assigned to the LDH-like compound is detected typically in the range of 5°≤2θ≤0°, and more typically in the range of 7°≤2θ≤0°. As described above, the LDH is a substance having an alternating laminated structure in which exchangeable anions and H₂O are present as an intermediate layer between the stacked hydroxide basic layers. In this regard, when LDH is analyzed by the X-ray diffraction method, a peak assigned to the crystal structure of LDH (i.e., the peak assigned to (003) of LDH) is originally detected at a position of 2θ=11 to 12°. When the LDH-like compound is analyzed by the X-ray diffraction method, on the other hand, a peak is typically detected in the aforementioned range shifted to the lower angle side than the above peak position of LDH. Further, the interlayer distance of the layered crystal structure can be determined by Bragg's equation using 28 corresponding to the peak assigned to the LDH-like compound in X-ray diffraction. The interlayer distance of the layered crystal structure of the LDH-like compound thus determined is typically 0.883 to 1.8 nm, and more typically 0.883 to 1.3 nm.

The LDH separator by the aforementioned aspect (a) has an atomic ratio of Mg/(Mg+Ti+Y+Al) in the LDH-like compound, as determined by energy dispersive X-ray spectroscopy (EDS), which is preferably 0.03 to 0.25 and more preferably 0.05 to 0.2. Moreover, the atomic ratio of Ti/(Mg+Ti+Y+Al) in the LDH-like compound is preferably 0.40 to 0.97 and more preferably 0.47 to 0.94. Further, the atomic ratio of Y/(Mg+Ti+Y+Al) in the LDH-like compound is preferably 0 to 0.45 and more preferably 0 to 0.37. Further, the atomic ratio of Al/(Mg+Ti+Y+Al) in the LDH-like compound is preferably 0 to 0.05 and more preferably 0 to 0.03. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another preferred aspect (b) of the present invention, the LDH-like compound can be a hydroxide and/or oxide having a layered crystal structure containing (i) Ti, Y, and optionally Al and/or Mg and (ii) additive element M. Therefore, a typical LDH-like compound is a complex hydroxide and/or complex oxide of Ti, Y, additive element M, optionally Al and optionally Mg. Additive element M is In, Bi, Ca, Sr, Ba or combinations thereof. The above elements may be replaced with other elements or ions to an extent such that the basic characteristics of the LDH-like compound are not impaired, but the LDH-like compound preferably contains no Ni.

The LDH separator by the aforementioned aspect (b) has an atomic ratio of Ti/(Mg+Al+Ti+Y+M) in the LDH-like compound, as determined by energy dispersive X-ray spectroscopy (EDS), which is preferably 0.50 to 0.85 and more preferably 0.56 to 0.32. The atomic ratio of Y/(Mg+Al+Ti+Y+M) in the LDH-like compound is preferably 0.03 to 0.20 and more preferably 0.07 to 0.15. The atomic ratio of M/(Mg+Al+Ti+Y+M) in the LDH-like compound is preferably 0.03 to 0.35 and more preferably 0.03 to 0.32. The atomic ratio of Mg/(Mg+Al+Ti+Y+M) in the LDH-like compound is preferably 0 to and more preferably 0 to 0.02. Then, the atomic ratio of Al/(Mg+Al+Ti+Y+M) in the LDH-like compound is preferably 0 to 0.05 and more preferably 0 to 0.04. Within the above ranges, the alkali resistance is more excellent, and the effect of inhibiting a short circuit due to zinc dendrite (i.e., dendrite resistance) can be more effectively realized. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH. EDS analysis is preferably carried out with an EDS analyzer (for example, X-act, manufactured by Oxford Instruments Plc.), by 1) capturing an image at an acceleration voltage of 20 kV and a magnification of 5,000×, 2) carrying out three-point analysis at intervals of about 5 μm in the point analysis mode, 3) repeating the above 1) and 2) once more, and 4) calculating the average value of a total of 6 points.

According to another further preferred aspect (c) of the present invention, the LDH-like compound can be a hydroxide and/or oxide having a layered crystal structure containing Mg, Ti, Y, and optionally Al and/or In, wherein the LDH-like compound is present in a form of mixture with In(OH)₃. The LDH-like compound in this aspect is a hydroxide and/or oxide having a layered crystal structure containing Mg, Ti, Y, and optionally Al and/or In. Therefore, a typical LDH-like compound is a complex hydroxide and/or complex oxide of Mg, Ti, Y, optionally Al and optionally In. The In that can be contained in the LDH-like compound may be not only In intentionally added to the LDH-like compound but also that unavoidably mixed into the LDH-like compound, due to formation of In(OH)₃ or the like. The above elements can be replaced with other elements or ions to an extent that the basic characteristics of the LDH-like compound are not impaired, however, the LDH-like compound preferably contains no Ni. By the way, LDH conventionally known for LDH separators has the basic composition that can be represented by the formula: M²⁺₁₋ₓM³⁺ₓ(OH)₂Aⁿ⁻_{x/n}·mH₂O, wherein M²⁺ is a divalent cation, M³⁺ is a trivalent cation, Aⁿ⁻ is an n-valent anion, n is an integer of 1 or more, x is 0.1 to 0.4, and m is 0 or more. The atomic ratios in the LDH-like compound generally deviate from those in the above formula for LDH. Therefore, the LDH-like compound in the present aspect generally can be said to have a composition ratio (atomic ratio) different from that of the conventional LDH.

The mixture by the above aspect (c) contains not only the LDH-like compound but also In(OH)₃ (typically composed of the LDH-like compound and In(OH)₃). In(OH)₃ contained can effectively improve alkali resistance and dendrite resistance in LDH separators. The content proportion of In(OH)₃ in the mixture is preferably the amount that can improve alkali resistance and dendrite resistance with little impairment of hydroxide ion conductivity of the LDH separator, and is not particularly limited. In(OH)₃ may have a cubic crystal structure, and have a configuration in which the crystals of In(OH)₃ are surrounded by LDH-like compounds. In(OH)₃ can be identified by X-ray diffraction.

What is claimed is:

1. A zinc secondary battery, comprising:
a unit cell, comprising:
a positive electrode plate including a positive electrode active material layer;
a negative electrode plate including a negative electrode active material layer containing at least one selected from the group consisting of zinc, zinc oxide, a zinc alloy, and a zinc compound;
a nonwoven fabric covering or wrapping up each of the positive electrode plate and the negative electrode plate;
a hydroxide ion conductive separator separating the positive electrode plate and the negative electrode plate so as to make hydroxide ions conductable; and
an electrolytic solution; and
a battery container housing the unit cell,
wherein each of the positive electrode plate, the negative electrode plate, and the hydroxide ion conductive separator is vertically arranged, and an excessive portion of the electrolytic solution is always retained on a bottom of the battery container in an amount corresponding to a liquid level lower than lower ends of the positive electrode plate and the negative electrode plate regardless of change in an amount of the electrolyte caused by charge/discharge, and
wherein the nonwoven fabric covering or wrapping up the positive electrode plate has a lower extension portion contactable with the excessive portion of the electrolytic solution, and a lower end of the lower extension portion is always positioned below the liquid level of the excessive portion of the electrolytic solution regardless of change in an amount of the electrolyte caused by charge/discharge, whereby the nonwoven fabric is capable of absorbing the excessive portion of the electrolytic solution by capillary action thereof upward from the lower end thereof.

2. The zinc secondary battery according to claim 1, wherein the nonwoven fabric in contact with one surface of the positive electrode plate and the nonwoven fabric in contact with another surface of the positive electrode plate are thermally mutually welded in a part of the lower extension portions thereof to together form a welded portion, and a remaining part of the lower extension portions is an unwelded portion not thermally welded, and a lower end of the unwelded portion is always positioned below the liquid level of the excessive portion of the electrolytic solution.

3. The zinc secondary battery according to claim 1, wherein the nonwoven fabric has a thickness of 50 to 150 μm.

4. The zinc secondary battery according to claim 1, wherein the nonwoven fabric is composed of at least one selected from polyolefin, cellulose, and vinylon.

5. The zinc secondary battery according to claim 1, wherein the negative electrode plate is covered or wrapped up with the hydroxide ion conductive separator from outside the nonwoven fabric covering or wrapping up the negative electrode plate.

6. The zinc secondary battery according to claim 1, wherein the hydroxide ion conductive separator is an LDH separator containing a layered double hydroxide (LDH) and/or an LDH-like compound.

7. The zinc secondary battery according to claim 6, wherein the LDH separator further includes a porous substrate, and is composited with the porous substrate with the LDH and/or the LDH-like compound filled in pores in the porous substrate.

8. The zinc secondary battery according to claim 7, wherein the porous substrate is made of a polymer material.

9. The zinc secondary battery according to claim 1, wherein the positive electrode active material layer contains nickel hydroxide and/or nickel oxyhydroxide, whereby the zinc secondary battery is configured as a nickel zinc secondary battery.

10. The zinc secondary battery according to claim 1, wherein the positive electrode active material layer is an air electrode layer, whereby the zinc secondary battery is configured as an air-zinc secondary battery.

11. The zinc secondary battery according to claim 1, comprising a plurality of the unit cells, whereby the plurality of the unit cells form a multilayer cell as a whole.
